(19) United States
(12) Patent Application Publication
(10) Pub. No.: US 2007/0183452 A1
(43) Pub. Date: Aug. 9, 2007

(54) Transport stream dejittering

(76) Inventors: Mark Hryszko, Doylestown, PA (US); Raul A. Casas, Doylestown, PA (US); Samir N. Hulyalkar, Newtown, PA (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/347,745

(22) Filed: Feb. 3, 2006

(51) Int. Cl. H04J 3/24

(52) U.S. Cl. 370/474

(57) ABSTRACT

An apparatus, configured to receive from a receiver a multiplexed data stream of multiplexed video data packets, the multiplexed data stream being produced from multiple input video streams received by the receiver. The apparatus includes a point-of-deployment (POD) module controller configured to use a POD module to decrypt the multiplexed data stream and a demultiplexor connected to the decryption module and configured to demultiplex the multiplexed data stream such that the video data packets are grouped in respective output video data streams, the demultiplexor being further configured to use timing information associated with the multiplexed data stream such that packets in the output video data streams have time spacings in accordance with the timing information.

### BACKGROUND

Modem cable systems distribute hundreds of channels' worth of programming to end users via a single cable. In order to bundle hundreds of channels together on a single cable, cable companies typically use signal modulation to distinguish the channels, such as quadrature amplitude modulation (QAM) and/or vestigial sideband (VSB) modulation. One or more channel tuners within a cable host (e.g., a set-top cable box, or tuner circuitry within a television itself) demodulate the QAM modulated signal and extract a demodulated QAM signal, such as an MPEG2 transport stream, for display on a television.

Cable companies usually encrypt some channels, such as pay-per-view channels, to prevent unauthorized viewing and/or pirating. These encrypted channels are typically decrypted by a decrypter such as a “point of deployment” access card, or “CABLECARD,” prior to being viewed. A CABLECARD is a small device (similar to a PCMCIA card for a laptop computer) that is designed to be inserted into a slot found on most modem televisions. The CABLECARD is typically provided by the end user's cable company and contains a decryption algorithm/key used to decrypt the signal provided by the cable company. Different cable systems generally use different CABLECARDS, which contain different decryption algorithms. The CABLECARD receives the demodulated MPEG2 transport stream, which it then decrypts, and forwards for display by the television.

Second generation CABLECARDS (e.g., CABLECARDS that conform to the Open CABLECARD 2.0 specification (OC-SP-CCIF2.0)) or MCARDS, are capable of decrypting multiple transport streams for display (e.g., when multiple transport streams are multiplexed into a single multiplexed transport stream). An end-user typically decrypts multiple transport streams simultaneously, for example when using picture-in-picture, when multiple televisions are connected to a single MCARD, and/or when multiple televisions are connected to a single video distribution box that uses a single MCARD. CABLECARDS, however, can introduce an indeterminate amount of delay into the demodulation/decryption process, which may affect the time spacing jitter of the data packets within the multiple transport streams. The quality of a resulting demultiplexed, decrypted transport stream may be reduced, compared to its corresponding pre-multiplexed signal or the transport stream may become unviewable.

### SUMMARY

In general, in an aspect, the invention provides an apparatus configured to receive from a receiver a multiplexed data stream of multiplexed video data packets, the multiplexed data stream being produced from multiple input video streams received by the receiver. The apparatus includes a point-of-deployment (POD) module controller configured to use a POD module to decrypt the multiplexed data stream and a demultiplexor connected to the decryption module and configured to demultiplex the multiplexed data stream such that the video data packets are grouped in respective output video data streams, the demultiplexor being further configured to use timing information associated with the multiplexed data stream such that packets in the output video data streams have time spacings in accordance with the timing information.

Implementations of the invention may include one or more of the following features. The demultiplexor is configured to demultiplex the multiplexed data stream using respective timing information associated with each of the video data packets of the multiplexed data stream. The demultiplexor is configured to demultiplex the multiplexed data stream using respective timing information contained in headers of the video data packets. The timing information includes respective time stamps in headers of the video data packets and the demultiplexor is configured to determine time spacings between packets in each of the respective video data streams. The demultiplexor includes a buffer, the demultiplexor being configured to store the demultiplexed data packets for respective periods of time in accordance with the timing information associated with the respective video data packets. The POD module controller and the demultiplexor are disposed on a semiconductor chip.

In general, in another aspect, the invention provides a multiplexor for use in a receiver configured to receive multiple encrypted input video data streams, the multiplexor module being configured to multiplex data packets of the multiple input video data streams into a multiplexed data stream of video data packets, and to associate timing information with the multiplexed data stream from which time spacings of the video data packets in the respective input video data streams can be determined by a demultiplexor.

Implementations of the invention may include one or more of the following features. The multiplexor is configured to associate respective timing information with each of the video data packets of the multiplexed data stream from which the time spacings of the video data packets in the respective input video data streams can be determined. The multiplexor is configured to add the timing information to headers of the video data packets to form the multiplexed data stream. The timing information is a time stamp. The timing information indicates a time that the multiplexor processed the video data packets. The timing information reflects a time that the apparatus processed the video data packets.

In general, in another aspect, the invention provides a system for use with a receiver configured to receive multiple encrypted input video data streams and to extract, from the input video data streams, multiple output video data streams for concurrent display, the system including a multiplexor configured to multiplex data packets of the multiple input video data streams into a multiplexed data stream of video data packets, and to associate timing information with the multiplexed data stream from which input time spacing of the video data packets in the respective input data streams can be determined, a decryption module connected to the multiplexor being configured to decrypt the multiplexed data stream, and a demultiplexor connected to the decryption module and configured to demultiplex the multiplexed data stream such that the video data packets are grouped in respective output video data streams, the demultiplexor being further configured to use the timing information such that packets in the output video data streams have time spacings substantially equal to the input time spacing of corresponding data packets in corresponding input video data streams.

Implementations of the invention may include one or more of the following features. The multiplexor is configured to associate respective timing information with each of the video data packets of the multiplexed data stream from which the time spacing of the video data packets in the respective input video data streams can be determined. The multiplexor is configured to add respective timing information to headers of the video data packets to form the multiplexed data stream. The timing information is a time stamp. The timing information indicates a time that the video data packets were processed by the receiver. The demultiplexor includes a buffer, the demultiplexor being configured to store the demultiplexed data packets for respective periods of time in accordance with the timing information associated with the respective video data packets.

Various aspects of the invention may provide one or more of the following capabilities. Time spacing of data packets in a demodulated data stream can be maintained during the decryption process. Jitter of decrypted data packets may be reduced or even eliminated, compared to prior techniques. Multiplexing and demultiplexing of several transport streams may be accomplished without altering a data payload field of a transport stream packet. Multiple encrypted channels may be viewed on a single television at once (e.g., picture-in-picture).

These and other capabilities of the invention, along with the invention itself, will be more fully understood after a review of the following figures, detailed description, and claims.

### BRIEF DESCRIPTION OF THE FIGURES

FIG. 1 is a block diagram of a cable television system using a CABLECARD.

FIG. 2 is a block timing diagram of multiple transport streams prior to multiplexing, after multiplexing, and after demultiplexing.

FIG. 3 is a block diagram of an MPEG2 data packet.

FIG. 4 is a block flow diagram of a process of multiplexing and demultiplexing multiple transport streams.

### DETAILED DESCRIPTION

Embodiments of the invention provide techniques for multiplexing and demultiplexing multiple transport streams while substantially eliminating jitter and maintaining the information time spacing of incoming transport streams. For example, a cable host receives an encrypted QAM or VSB modulated signal from a cable provider. Tuners demodulate the signal into two separate transport streams, e.g., MPEG2 transport streams. The transport streams are transmitted to a multiplexor that uses time division multiplexing (TDM) to combine the multiple transport streams into a single transport stream. During the multiplexing process, the multiplexor adds a time stamp to the header of each multiplexed data packet reflecting a time when the packet was received by the multiplexor. The multiplexed single transport stream is transmitted to a CABLECARD that decrypts encrypted channels and transmits a decrypted multiplexed transport stream to a demultiplexor. The demultiplexor demultiplexes the decrypted multiplexed transport stream into multiple decrypted transport streams, using the time stamps, such that the packet timing of each of the decrypted, demultiplexed streams is similar to that of the corresponding stream before multiplexing. The demultiplexed streams are displayed on a television. Other embodiments are within the scope of the invention.

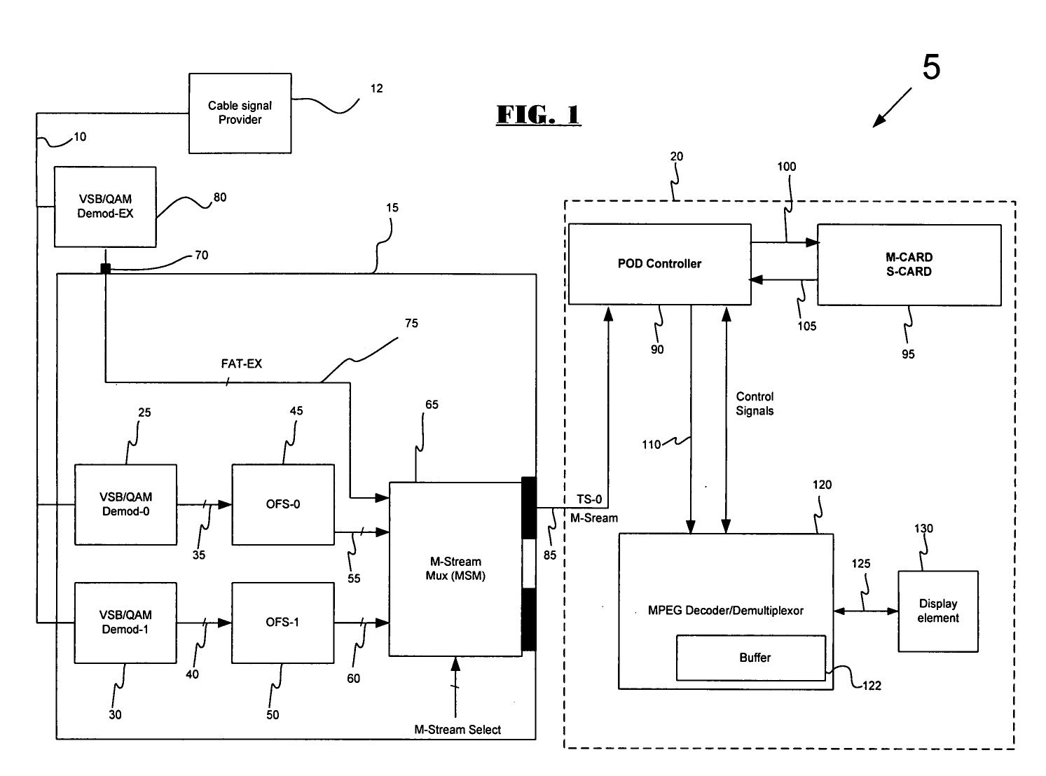

Referring to FIG. 1, a cable television system 5 includes a cable signal provider 12, a cable host 15, and a display system 20. The cable signal provider 12 is configured to supply a cable signal 10 that is, for example, a QAM64, or a QAM 256 modulated signal, although other modulation schemes are possible. The cable signal 10 typically contains many channels of programming and/or other data for use by an end user. The cable host 15 is a standard set-top cable box that can demodulate the cable signal 10 into a signal format used by the display system 20. While here the cable host 15 is a set-top box, other configurations are possible, such as incorporating the host 15 into a “digital cable ready” television instead of using a separate set-top box. The system 5 is configured such that signals provided by the cable signal provider 12 are demodulated by the cable host 15 and processed and displayed (e.g., the visual information contained within the signals is displayed) by the display system 20.

The cable host 15 includes demodulators 25 and 30, output format smoothers 45 and 50, a multiplexor 65, and an external transport stream connector 70. The demodulators 25 and 30 are connected to the cable provider 12 and are configured to receive and demodulate the cable signal 10 from a QAM or VSB format and output demodulated transport streams 35 and 40, respectively, which are, for example, in MPEG2 format. Each of the demodulators 25 and 30 preferably can function as a tuner circuit to select a specific channel in response to an end user's request. For example, in response to a user choosing to view “channel 44,” one of the demodulators 25, 30 will demodulate the cable signal 10, and isolate the portion of the cable signal 10 corresponding to channel 44. The demodulators 25 and 30 are connected and configured to output the demodulated transport stream 35 and 40 to the output format smoothers 45 and 50, respectively. The output format smoothers 45 and 50 can de-jitter the demodulated transport stream and/or produce an output with a constant data rate. The transport streams 55 and 60 are transmitted to the multiplexor 65 from the output format smoothers 45 and 50. While the output format smoothers are shown in FIG. 1, the output format smoothers 45 and/or 50 may be omitted (e.g., the demodulators 25 and/or 30 may be connected directly to the multiplexor 65).

The multiplexor 65 is connected to the output format smoothers 45 and 50 to receive the streams 55 and 60, and is connected to an external demodulator 80 and is configured to receive an external transport stream 75 from the external demodulator 80, via the external transport stream connection 70. The external demodulator 80 is an external input using a protocol compatible with the multiplexor 65 (e.g., MPEG2). For example, the demodulator 80 may be another tuner, a DVD player, a digital VCR, a hard-drive recorder, a computer video stream, etc.

The multiplexor 65 can multiplex the transport streams 55, 60, and 75 into a single multiplexed transport stream 85. The multiplexor 65 is configured to add timing information, (e.g., timing information reflecting a time when the multiplexor receives the transport stream 55, when the demodulator 25 receives the cable signal 10, when the multiplexor 65 multiplexes the transport streams 55, 60, and 75) to the information in the transport streams 55, 60, and 75 to form the multiplexed transport stream 85. The multiplexor 65 is connected, and can transmit the multiplexed transport stream 85, including the additional timing information, to the display system 20. The added timing information indicates the relative timing of receipt of packets in each of the transport streams 55, 60, and 75. The relative timing information may take various forms. For example, the timing information can be absolute time (e.g., time of day), relative time (e.g., delay times) from the first packet to the current packet, relative time (delay times) from the previous packet to the current packet, a value representative of a repetitive increment between data packets (e.g., a number that represents a uniform time increment between data packets), etc. Timing information can be in each packet, or, for example, in the case of repetitive increments, the timing information can be sent as part of a first packet, or first of several packets, with later packets identifying stream and packet number, with timing being calculable. Adding the timing information can occur in various ways such as replacing existing timing information in a data packet, changing a timing information field from all zeros and/or ones (as in binary zeros and ones) to a value representative of the timing information, creating a new timing information field, etc. The timing information can be generated by the multiplexor 65 using a counter operating at 108 MHz. The counter is based off a 27 MHz clock (e.g., the timing of the counter can be controlled by the 27 MHz clock).

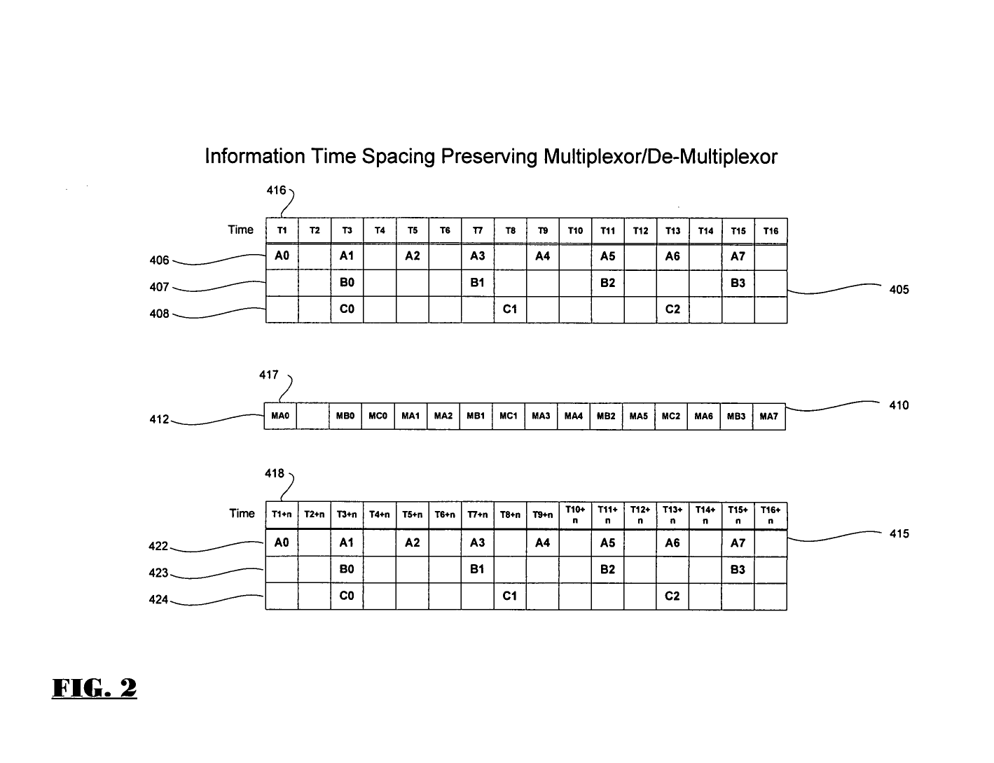

Referring also to FIG. 2, a table 405 shows data packets received by the multiplexor 65 from three input transport streams, 406, 407, and 408. The portions of the transport streams 406, 407, 408 shown include packets A0 through A7, B0 through B3, and C0 through C2, respectively. Here, the data packets from each of the transport streams 406, 407, and 408 arrive at the times corresponding to the column the packets are shown in, corresponding to arrival times T1 through T16. The data packets in the different streams 406, 407, and 408 arrive with different time intervals between the packets, although within the different streams 406, 407, and 408, the packets have similar time spacings between them. Here, the data packets A0 through A7 from the transport stream 406 arrive every other time slot (here, T1, T3, T5, T7, T9, T11, T13, and T15) whereas data packets from the transport stream 407 arrive every fourth time slot (here, T3, T7, T11, T15). This equal spacing between packets within each of the streams 406, 407, and 408 is not required.

A table 410 shows a multiplexed transport stream 412 transmitted by the multiplexor 65 to the display system 20. The multiplexor 65 is configured to combine the packets of the streams 406, 407, and 408 into the single stream 412. The multiplexor 65 implements a priority algorithm such as first-in-first-out (FIFO), last-in-first-out (LIFO), or priority weighting to put the data packets in order in the multiplexed transport stream 412. Each of the input transport streams 406, 407 and/or 408 may be given a specific priority such that if a packet of a higher-priority stream arrives at the same time as, or when a packet of a lower-priority stream is waiting to be put in the multiplexed stream 412, the packet from the higher-priority packet will be placed in the multiplexed stream 412 before the packet from the lower-priority stream. For example, as shown in the tables 405 and 410, the transport stream 407 has a higher priority than the transport stream 408, which has a higher priority than the transport stream 406. The multiplexor 65 is configured such that if a buffer of the multiplexor 65 contains a data packet from each of the transport streams 406, 407, and 408 waiting to be transmitted, then the multiplexor 65 will transmit the data packet from the transport stream 407 first, then the data packet from the transport stream 408, and then the data packet from the transport stream 406.

The tables 405, 410, and 415 may correspond to different absolute times. The data packets represented by the table 415 are output at some time (n) after the data packets represented by the table 405 are received. For example, if the multiplexor 65 causes 10 milliseconds of delay, then T1+n is at least 10 milliseconds after T1. The delay (n) may be caused by delays inherent in, for example, the multiplexing, decryption, and demultiplexing processes.

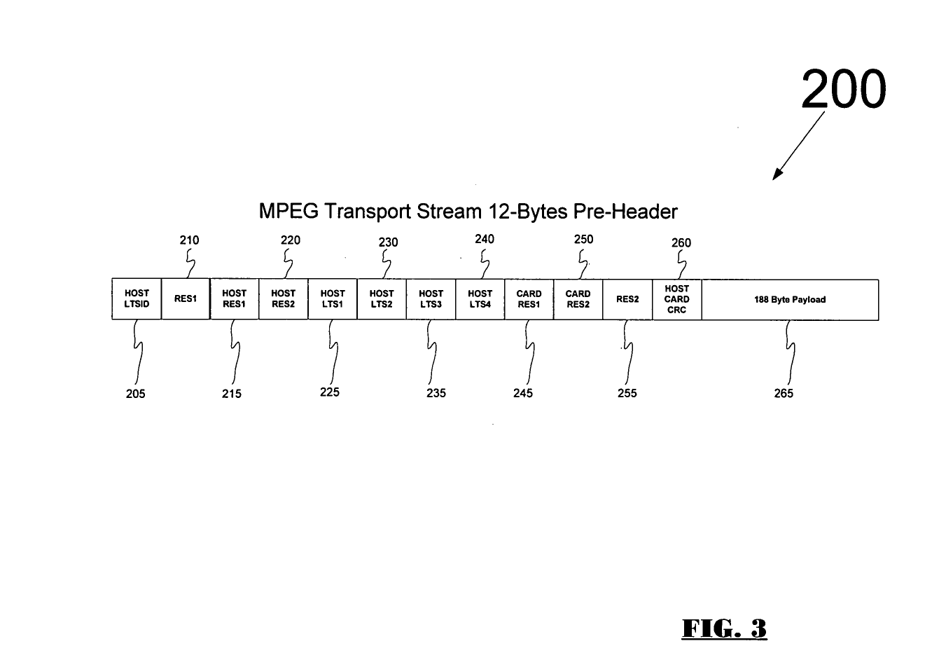

Referring also to FIG. 3, an extended MPEG2 transport stream data packet 200 includes header fields 205, 210, 215, 220, 225, 230, 235, 240, 245, 250, 255, and 260, and a payload 265. Each of the header fields 205, 210, 215, 220, 225, 230, 235, 240, 245, 250, 255, and 260 are 1 byte long, and the payload 265 is 188 bytes long, although other configurations are possible (e.g., the data packet 200 may be longer than 200 bytes). The data packet 200 represents a data packet sent between the cable host 15 and the display system 20 or between the cable provider 12 and the host 15. The field 205 is a host generated transport stream ID, which is the same for each packet within a single transport stream, and is unique to each transport stream. The field 205 is preferably used by the display system 20 to determine to which particular transport stream 55, 60, and 75 the data packet 200 belongs. The field 210 is reserved for use by something other than the host 15 or CABLECARD. The fields 215 and 220 are reserved for use by the host. The fields 225, 230, 235, and 240 contain the timing information generated by the multiplexor 65. The fields 245 and 250 are reserved for use by the CABLECARD as defined in the CABLECARD 2.0 specification. The field 260 contains a cyclic redundancy check (CRC) byte generated by the host 15 and/or the CABLECARD for use in error correction. While the header fields are shown at the beginning of the packet 200, the header may be located at the middle and/or end of a data packet and/or may be any non-payload portion of a data packet.

Timing information is provided in each packet in the multiplexed data stream 412 to indicate the timing of the particular data packet in its corresponding stream. For example, the multiplexed packed MA0 includes timing information as does the multiplexed packet MA1. From the information contained in these two packets MA0, MA1, the relative time spacing of the demultiplexed packets A0 and A1 can be determined corresponding to the stream 406. The same is true for other packets of the stream 406, as well as for the streams 407, 408. Here the timing information is time stamps reflective of absolute time, from which the time separation of the two packets can be calculated. The timing information for each multiplexed packet is thus different in this example, but the relative time separation between packets of common streams can readily be determined.

Referring again to FIG. 1, the display system 20 includes a point-of-deployment (POD) module controller (here, the M-Card controller 90), a POD module (here, the M-Card 95), a decoder 120, and a display element 130. The display system 20 is, for example, a POD-enabled television including a CABLECARD slot, but other configurations are possible (e.g., the display element 130 may be located remotely from the M-Card controller 90, the M-Card 95, and the decoder 120).

The M-Card controller 90 is responsible for controlling and interfacing with the M-Card 95 via connections 100 and 105. The M-Card controller 90 is connected and configured to receive the multiplexed transport stream 85 from the multiplexor 65. Portions of the data contained within the multiplexed transport stream 85 are encrypted. The M-Card controller 90 is configured to transmit the encrypted multiplexed transport stream 85 to the M-Card 95. The M-Card 95 preferably conforms to the CABLECARD interface 2.0 specification (OC-SP-CCIF2.0-102-050708), although other configurations are possible. The M-Card 95 is configured to decrypt the encrypted information contained within the transport stream 85, and transmit the decrypted multiplexed signal to the M-Card controller 90 via the connection 105. The M-Card controller 90 can forward the decrypted multiplexed signal to the decoder 120 as a transport stream 110. Alternatively, the M-Card 95 may only decrypt a portion of the transport stream 85 (e.g., when a viewer is not authorized to view all of the channels contained in the transport stream 85).

The decoder 120 can demultiplex and/or decode the information contained within the transport stream 110 and transmit the demultiplexed and/or decoded information to the display element 130 via a video signal 125 for display to an end user. The decoder 120 is preferably a decoder such as a Xilleon X260 (manufactured by ATI Technologies, of Markham, Ontario, Canada), although other demultiplexors may be used. The decoder 120 preferably contains a memory such as a buffer 122 used in the demultiplexing process, although other configurations are possible (e.g., the buffer being located externally to the decoder 120). The buffer 122 can store demultiplexed data packets prior to being transmitted to the display element 130. The decoder 120 is configured to store the demultiplexed data packets in the buffer 122 for appropriate amounts of time, as indicated by the timing information provided by the multiplexor 65, to maintain the time spacing of a particular transport stream. For example, referring also to FIG. 2, in reconstructing transport stream 408, if the packet C1 is received by the decoder 120 during the same time interval that the packet C0 is being transmitted to the display element 130, the decoder 120 will hold the packet C1 in the buffer 122 for five time intervals before transmitting the packet C1 as part of a stream 424, thereby reproducing the five-interval time spacing of the data packets C0 and C1 within the transport stream 408.

The decoder 120 is configured to demultiplex the stream 110, which is similar in format to the stream 412, assuming the input stream portions 406, 407 and 408. The decoder 120 is configured to analyze the timing information of each packet to space the packets in time similar to their spacing in time in the streams 406, 407 and 408. Thus, as shown in table 415, with the multiplexed data stream 412 shown in the table 410 as an input, the decoder 120 can reconstruct the transport streams 406, 407, and/or 408 as transport streams 422, 423, and/or 424 with substantially the original time spacing of each data packet relative to the other packets. The decoder 120 can reconstruct the transport streams 406, 407, and 408, by, for example, holding each packet in a buffer and inserting each packet as appropriate as indicated by the timing information contained within each packet. Thus, the time spacing of each of the information streams 406, 407, and 408 is preserved, thereby reducing and possibly eliminating jitter introduced by the multiplexing process.

The display element 130 is preferably a television screen, but other configurations are possible (e.g., a projector, computer screen, etc.). The display element 130 can display information from more than one transport stream at a time using, for example, picture-in-picture technology. While the display element 130 is shown in FIG. 1 as part of the display system 20, the display element 130 may be located external to the display system 20.

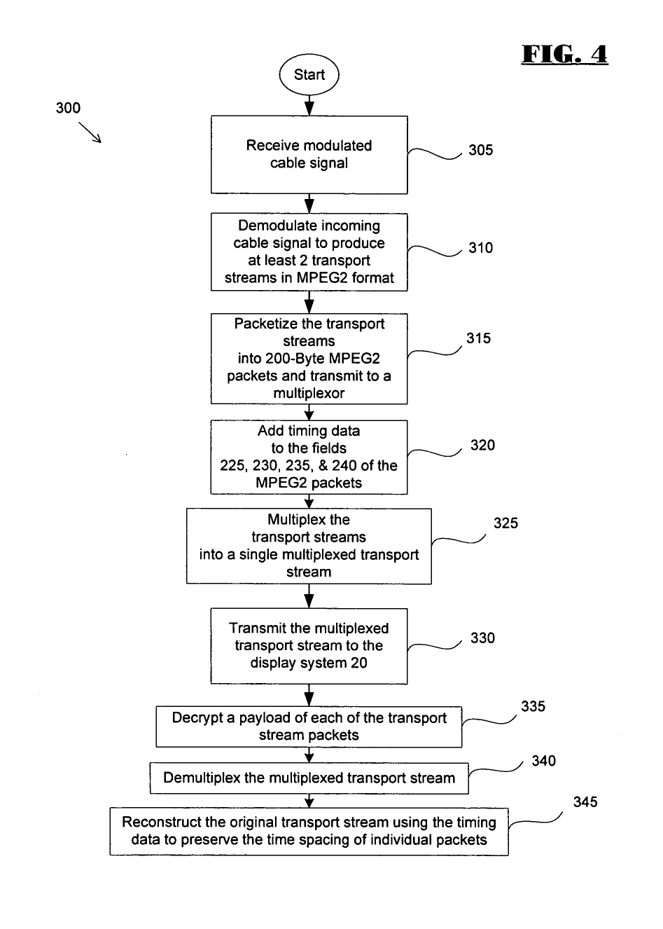

In operation, referring to FIG. 4, with further reference to FIGS. 1-3, a process 300 for producing a demultiplexed MPEG2 transport stream with reduced jitter using the cable system 5 includes the stages shown. In the process 300, multiple transport streams (e.g., the transport streams 406, 407, and/or 408) are multiplexed and demultiplexed using time spacing preservation to reduce and possibly eliminate jitter. The process 300 is exemplary only and not limiting. The process 300 may be altered, e.g., by adding, removing, and/or changing stages.

At stage 305, the cable host 15 receives the cable signal 10 from the cable signal provider 12. Here, the cable signal 10 is modulated using QAM64 or QAM256 modulation.

At stage 310 the demodulators 25, 30, 80 demodulate the cable signal 10 into multiple transport streams, here the transport streams 406, 407. An external input from an end user controls which specific channels are demodulated by the demodulators 25 and 30. For example, here the end user chooses to view HBO® and Showtime®, which correspond to cable channels 26 and 76. The demodulator 25 demodulates channel 26 into the first transport stream 406 in MPEG2 format. The demodulator 30 demodulates channel 76 into the second transport stream 407 in MPEG2 format. Further, the external demodulator 80 demodulates the cable signal 10 (or another source such as a DVD player) and provides the transport stream 75, here the stream 408, to the multiplexor 65

At stage 315, the demodulators 25, 30, 80 packetize the multiple MPEG2 transport streams into multiple MPEG2 data packets that are each substantially similar to the data packet 200. Each of the MPEG2 data packets are similar to the packet 200, being 200-byte long data packets, with the first 12 bytes being header information, the remaining 188 bytes containing the MPEG2 data payload. The MPEG2 data packets are transmitted to the multiplexor 65 as the streams 406, 407, and 408.

At stage 320, the multiplexor 65 receives the MPEG2 streams 406, 407, 408 and adds timing information, here to each of the MPEG2 data packets as a function of when the multiplexor 65 received each of the MPEG2 data packets. The MPEG2 data packets are configured in the format as shown in FIG. 3. The multiplexor 65 adds the timing information to non-payload portions of the data packet 200, here the header fields 225, 230, 235, and/or 240, although other header fields may be used. More than one piece of timing information may be added to the header (e.g., different timing information in each of the header fields 225, 230, 235 and/or 240).

At stage 325, the multiplexor 65 multiplexes the MPEG2 data packets into a single multiplexed transport stream (here, the transport stream 412) using time-division multiplexing (TDM). The multiplexor 65 multiplexes the MPEG2 data packets according to a priority algorithm. For example, during the multiplexing process, the multiplexor 65 can insert the highest priority packet contained in a buffer of the multiplexor 65 into the transport stream 412. The multiplexor 65 packetizes the multiplexed transport stream into MPEG2 data packets. At stage 330, the multiplexed transport stream is transmitted to the display system 20.

At stage 335, the M-Card 95 decrypts the payload of each of the multiplexed MPEG2 data packets using a decryption key/algorithm provided by the end user's cable provider. During the decryption process, the M-Card 95 preserves much of the original header information, including the time stamp contained within the header fields 225, 230, 235, and/or 240, and the information contained within the header field 205. The decrypted multiplexed data packets are transmitted by the M-Card 95 to the decoder 120.

At stage 340, the decoder 120 demultiplexes the decrypted multiplexed data packets, modulating separate transport streams. The decoder 120 separates the data packets into groups according to each of the individual MPEG2 transport streams using the host generated transport stream ID contained within the header field 205.

At stage 345, the decoder 120 uses the timing information contained within the header of each of the decrypted data packets to adjust, as appropriate, the time spacing of the demultiplexed packets. The decoder 120 analyzes the timing information contained in the packet and transmits the packets at appropriate times to the display 130 and stores the decrypted data packets for times in accordance with the timing information to attempt to match packet time separation of the streams 406, 407, 408, to produce the streams 422, 423, 424. Thus, the decoder 120 substantially reproduces the time spacing of the original packets in the individual information streams 406, 407, 408.

The process 300 repeats indefinitely, so long as the cable system 5 is in operation, at least one specific channel is chosen and/or an external source is providing an encrypted signal.

Other embodiments are within the scope of the invention. For example, the process 300 is representative only, and not limiting. As shown, the process 300 receives modulated cable signals from the cable provider 12, which are modulated using QAM64 and/or QAM256. The cable provider 12, however, may use other modulation schemes. The cable signal 10 may be provided from other sources than the cable provider 12 such as encrypted DVD signals, encrypted streaming video from a computer, unencrypted data streams, and/or other network data streams. The transport streams may include multiple program streams. Also, in stage 315, other packet sizes and/or formats are possible such as using MPEG4 or MPEG7 formats and/or larger data packets (e.g., 400-byte packets). During the stage 325, multiplexing schemes other than time-division multiplexing are possible, for example, frequency-division multiplexing (FDM) and/or space-division multiplexing (SDM) can be used.

While a cable host has been described above with respect to the cable host 15 in FIG. 1, other configurations are possible. For example, the cable host 15 may be contained within the display system 20, such as in a “digital cable ready” television, or in other audio/visual components, such as DVD players, VCRs, hard-drive recorders, satellite receivers, etc. While the multiplexor 65 has been described as including three inputs (i.e., transport streams 55, 60, and 75), other configurations are possible (e.g., five transport streams received from five demodulators contained within the cable host 150). Cable hosts without the output format smoothers 45 and 50 are possible. Additional components may be added to the cable host 15 such as a hard-drive recording unit (e.g., a digital video recorder (DVR)), additional demodulators, additional audio and video outputs, network connections, Ethernet connections, telephone connections, serial communication ports, multiple display connections, etc.

Variations of the cable signal 10 are possible. The cable signal 10 may originate from other sources such as a satellite television provider, a closed-circuit television system, an Internet video stream, a DVD player, a digital VCR, a hard-drive recorder (e.g., a TIVO® unit), etc. The cable signal 10 may be modulated using other modulation schemes such as amplitude modulation (AM), frequency modulation (FM), amplitude-shift keying, frequency-shift keying, phase-shift keying, quadrature phase-shift keying, pulse code modulation, delta modulation, spread spectrum, etc. The cable signal 10 may include unencrypted data. The cable signal 10 may include only a single signal channel. The cable signal 10 may be bi-directional (e.g., interactive programming). The cable signal 10 may include non-video data (e.g., data packets used with the Internet).

While the cable host 15 and the display system 20 are shown as separate components, other configurations are possible. For example, functionality provided by the cable host 15 and the display system 20 may be combined into a single component, such as a CABLECARD.

While the data packet 200 has been described as a 200-byte MPEG2 data packet, other configurations are possible. For example, other compression standards may be used such as MPEG1, MPEG3, MPEG4, MPEG7, MPEG21, Resource Interchange File Format (RIFF), Audio Video Interleaved (AVI), QuickTime®, etc.

A “data packet” can refer to packets of non-identical content. For example, header information can vary, timing information can be inserted and/or removed, the payload portion of the data packet can vary while maintaining the same substantive content (e.g., an encrypted signal and decrypted signal may contain the same substantive information), etc., and these packets can be referred to as the same packet. As yet another example, as an Ethernet packet travels across the Internet, it is considered the same packet even though infrastructure devices (e.g., routers, switches, etc.) routinely change information contained within the packet (e.g., address information, number of hops, etc.).

The term “connected,” as used herein, includes direct connection and/or indirect connections through other components. For example, two components connected to each other include indirect connections through other components such as resistors, transistors, buffers, routers, switches, hubs, processors, decrypters, etc.

While the video signal 125 is shown providing data packets to the display element 130, the video signal 125 may provide data packets to other components as well. For example, decrypted demultiplexed data packets may be provided to the display element 130 and another device such as a digital video recorder.

Still other embodiments are within the scope and spirit of the invention. For example, functions described above can be implemented using software, hardware, firmware, hardwiring, or combinations of any of these. Field programmable gate arrays (FPGAs) may be used to implement features described herein. Features implementing functions may also be physically located at various positions, including being distributed such that portions of functions are implemented at different physical locations. The demodulators 25 and 30 can be portions of a single device. The timing information may associated with a particular data packet (e.g., using a unique identifier) and be transmitted in a data packet separate from the MPEG2 data (e.g., timing information may be transmitted in other data packets, other transport streams, etc.). Timing information can be inserted by a device other than the multiplexor 65. For example, timing information can be added to each stream as each stream is received, by the host 15 before the multiplexor 65, before the demodulators 25 and 30, and/or before the output format smoothers 45 and 50. The cable host 15, the M-Card controller 90, and the decoder 120 may be disposed on a semiconductor chip individually, or in combination with other components. Multiplexing schemes other than time-division multiplexing are possible, for example, frequency-division multiplexing (FDM) and/or space-division multiplexing (SDM) can be used.

Further, while the description above refers to the invention, the description may include more than one invention.

What is claimed is:

1. An apparatus configured to receive from a receiver a multiplexed data stream of multiplexed video data packets, the multiplexed data stream being produced from multiple input video streams received by the receiver, the apparatus comprising:
a point-of-deployment (POD) module controller configured to use a POD module to decrypt the multiplexed data stream; and
a demultiplexor connected to the decryption module and configured to demultiplex the multiplexed data stream such that the video data packets are grouped in respective output video data streams, the demultiplexor being further configured to use timing information associated with the multiplexed data stream such that packets in the output video data streams have time spacings in accordance with the timing information.

2. The apparatus of claim 1 wherein the demultiplexor is configured to demultiplex the multiplexed data stream using respective timing information associated with each of the video data packets of the multiplexed data stream.

3. The apparatus of claim 2 wherein the demultiplexor is configured to demultiplex the multiplexed data stream using respective timing information contained in headers of the video data packets.

4. The apparatus of claim 2 wherein the timing information comprises respective time stamps in headers of the video data packets and the demultiplexor is configured to determine time spacings between packets in each of the respective video data streams.

5. The apparatus of claim 1 wherein the demultiplexor comprises a buffer, the demultiplexor being configured to store the demultiplexed data packets for respective periods of time in accordance with the timing information associated with the respective video data packets.

6. The apparatus of claim 1 wherein the POD module controller and the demultiplexor are disposed on a semiconductor chip.

7. A multiplexor for use in a receiver configured to receive multiple encrypted input video data streams, the multiplexor module being configured to multiplex data packets of the multiple input video data streams into a multiplexed data stream of video data packets, and to associate timing information with the multiplexed data stream from which time spacings of the video data packets in the respective input video data streams can be determined by a demultiplexor.

8. The multiplexor of claim 7 wherein the multiplexor is configured to associate respective timing information with each of the video data packets of the multiplexed data stream from which the time spacings of the video data packets in the respective input video data streams can be determined.

9. The multiplexor of claim 8 wherein the multiplexor is configured to add the timing information to headers of the video data packets to form the multiplexed data stream.

10. The multiplexor of claim 9 wherein the timing information is a time stamp.

11. The multiplexor of claim 10 wherein the timing information indicates a time that the multiplexor processed the video data packets.

12. The multiplexor of claim 10 wherein the timing information reflects a time that the apparatus processed the video data packets.

13. A system for use with a receiver configured to receive multiple encrypted input video data streams and to extract, from the input video data streams, multiple output video data streams for concurrent display, the system comprising:
a multiplexor configured to multiplex data packets of the multiple input video data streams into a multiplexed data stream of video data packets, and to associate timing information with the multiplexed data stream from which input time spacing of the video data packets in the respective input data streams can be determined;
a decryption module connected to the multiplexor being configured to decrypt the multiplexed data stream; and
a demultiplexor connected to the decryption module and configured to demultiplex the multiplexed data stream such that the video data packets are grouped in respective output video data streams, the demultiplexor being further configured to use the timing information such that packets in the output video data streams have time spacings substantially equal to the input time spacing of corresponding data packets in corresponding input video data streams.

14. The system of claim 13 wherein the multiplexor is configured to associate respective timing information with each of the video data packets of the multiplexed data stream from which the time spacing of the video data packets in the respective input video data streams can be determined.

15. The system of claim 14 wherein the multiplexor is configured to add respective timing information to headers of the video data packets to form the multiplexed data stream.

16. The system of claim 14 wherein the timing information is a time stamp.

17. The system of claim 14 wherein the timing information indicates a time that the video data packets were processed by the receiver.

18. The system of claim 13 wherein the demultiplexor comprises a buffer, the demultiplexor being configured to store the demultiplexed data packets for respective periods of time in accordance with the timing information associated with the respective video data packets.
